(19) United States
(12) Patent Application Publication
(10) Pub. No.: US 2017/0162166 A1
(43) Pub. Date: Jun. 8, 2017

(54) Method Of Driving, Driving Device And Display Device

(71) Applicant: Shenzhen China Star Optoelectronics Technology Co. Ltd., Shenzhen, Guangdong (CN)

(72) Inventors: Chih-tsung KANG, Shenzhen, Guangdong (CN); Lixuan CHEN, Shenzhen, Guangdong (CN)

(73) Assignee: Shenzhen China Star Optoelectronics Technology Co. Ltd., Shenzhen, Guangdong (CN)

(21) Appl. No.: 14/787,832

(22) PCT Filed: Aug. 26, 2015
(86) PCT No.: PCT/CN2015/088160

§ 371 Date: Oct. 29, 2015

(30) Foreign Application Priority Data
Jun. 16, 2015 (CN) 201510334538.0

(51) Int. Cl. G09G 3/36

(52) U.S. Cl. CPC G09G 3/3696; G09G 3/3677; G09G 3/3688; G09G 2310/08; G09G 2330/00

(57) ABSTRACT

A method of driving a display panel includes: outputting scan signal to each scan line of a display panel, with the scan signal including periodical frame signals, with each frame signal including: a first voltage that maintains each scan line in an on state during a first period of time, with the first voltage being a first DC high-level voltage; a second voltage that maintains each scan line in an off state during a second period of time, with the second voltage being an AC voltage outputting a second low-level voltage and a second high-level voltage alternately. The present invention changes a second voltage in charge of maintaining scan lines in an off state into a second low-level voltage and a second high-level voltage which output alternately. It effectively improves changes in leakage current of TFT, and improves image sticking appears on display devices.

### BACKGROUND OF THE INVENTION

1. Field of the Invention

The present invention relates to liquid crystal display (LCD) technology, and more specifically, to a method of driving and a driving device and display device that apply the method of driving.

2. Description of the Prior Art

Image sticking is an undesirable phenomenon often seen on LCD monitors. When the monitor has been showing a static image for a long period of time, the liquid crystal is polarized because it has been driven for a long period of time as well. Therefore, the liquid crystal molecules cannot turn as normal under the control of signal voltage. After a while, even if content of the image on display is changed, traces of the previous static image can still be seen on the screen. Based on different states after the image on display is changed, image sticking can be area sticking or line ship sticking.

When liquid crystal molecules are applied with a positive voltage, because of effects of coupled voltage and parasitic voltage, the rechargeable power of pixels will undergo a weak lowering process and partial loss of voltage within the pixels when the gate signal disappears, that is, when the gate signal is in its falling edge. When liquid crystal molecules are applied with reverse current to recharge, there is also a slight loss of voltage after the recharging is completed. Given the abovementioned reasons, asymmetry of voltage exists in pixels on opposite direction after discharging and recharging is completed. Therefore, a direction current (DC) is generated inevitably in the liquid crystal cell when the LCD discharges or recharges. When the retention DC is large enough, it prevents liquid crystal molecules from being driven by the signal voltage, and thus image sticking is generated.

The industry often adopts polarity reversal of driving voltages to improve image sticking resulted from polarized electrical fields. But because of contaminated materials, ill manufacturing process or other reasons, image sticking often occurs when static images have been on display for a long period of time.

Therefore, it is necessary to provide a method of driving, driving device and display device to solve the existing technical problems.

### SUMMARY OF THE INVENTION

An object of the present invention is to provide a method of driving, driving device and display device that improves image sticking to overcome the insufficiency of existing technology.

According to the present invention, a method of driving a display panel comprises:

outputting a scan signal to each scan line of a display panel, with the scan signal comprising a plurality of frame signals generated based on a frame period, with each frame signal comprising:

a first voltage that maintains each scan line in an on state during a first period of time, with the first voltage being a first high-level voltage of direct current (DC);

a second voltage that maintains each scan line in an off state during a second period of time, with the second voltage being an alternating current (AC) voltage outputting a second low-level voltage and a second high-level voltage alternately;

wherein the first high-level voltage is larger than the second high-level voltage.

Furthermore, the first voltage further comprises a chamfering voltage that decreases linearly or nonlinearly at the end of the first high-level voltage.

Furthermore, the range of the first voltage is 27V to 33V.

Furthermore, the second low-level voltage is larger than or equal to −4V, and the second high-level voltage is smaller than or equal to 4V.

Furthermore, the midpoint potential between the second low-level voltage and second high-level voltage is zero.

Furthermore, the frame period of the scan signal is 1/60 s.

Furthermore, the period of the second low-level voltage or second high-level voltage of the second voltage is smaller than or equal to that of the first high-level voltage of the first voltage.

Furthermore, the duration of the second low-level voltage and second high-level voltage is the same as that of the first high-level voltage.

Furthermore, the method further comprises: starting scan-driving by the first voltage of the scan signal on a (n+1)th scan line when scan-driving is completed by the first voltage of the scan signal on a nth scan line.

According to the present invention, a driving device comprises:

a scan driving circuit, electrically connecting to scan lines, to provide scan signals to scan lines;

a data driving circuit, electrically connecting to data lines, to provide data signals to data lines;

a timing controller to control signal timing of the scan driving circuit and data driving circuit;

wherein the scan driving circuit outputs a scan signal to each scan line of the display panel, with the scan signal comprising a plurality of fame signals generated based on a frame period, with each frame signal comprising:

a first voltage that maintains each scan line in an on state during a first period of time, with the first voltage being a first high-level voltage of DC;

a second voltage that maintains each scan line in an off state during a second period of time, with the second voltage being an AC voltage outputting a second low-level voltage and a second high-level voltage alternately;

wherein the first high-level voltage is larger than the second high-level voltage.

According to the present invention, a display device comprises a display panel and a driving device for driving the display panel. The display comprises a plurality of crossing scan lines and data lines. The driving device comprises:

a scan driving circuit, electrically connecting to scan lines, to provide scan signals to scan lines;

a data driving circuit, electrically connecting to data lines, to provide data signals to data lines;

a timing controller to control signal timing of the scan driving circuit and data driving circuit;

wherein the scan driving circuit outputs a scan signal to each scan line of the display panel, with the scan signal comprising a plurality of fame signals generated based on a frame period, with each frame signal comprising:

a first voltage that maintains each scan line in an on state during a first period of time, with the first voltage being a first high-level voltage of DC;

a second voltage that maintains each scan line in an off state during a second period of time, with the second voltage being an AC voltage outputting a second low-level voltage and a second high-level voltage alternately;

wherein the first high-level voltage is larger than the second high-level voltage.

The present invention changes a second voltage in charge of maintaining scan lines in an off state into a second low-level voltage and a second high-level voltage which output alternately. It effectively improves changes in leakage current of thin-film transistors (TFT) in the panel, and further improves image sticking appears on display devices. In addition, the method of driving is simple and easy to realize.

### BRIEF DESCRIPTION OF THE DRAWINGS

FIG. 1 shows a schematic diagram of a display device according a preferred embodiment of the present invention.

FIG. 2 shows a schematic diagram of a display panel according a preferred embodiment of the present invention.

FIG. 3 shows a waveform of a conventional scan signal.

FIG. 4 shows a waveform of scan signal according a first embodiment of the present invention.

### DETAILED DESCRIPTION OF PREFERRED EMBODIMENTS

For better understanding embodiments of the present invention, the following detailed description taken in conjunction with the accompanying drawings is provided. Apparently, the accompanying drawings are merely for some of the embodiments of the present invention. Any ordinarily skilled person in the technical field of the present invention could still obtain other accompanying drawings without use laborious invention based on the present accompanying drawings.

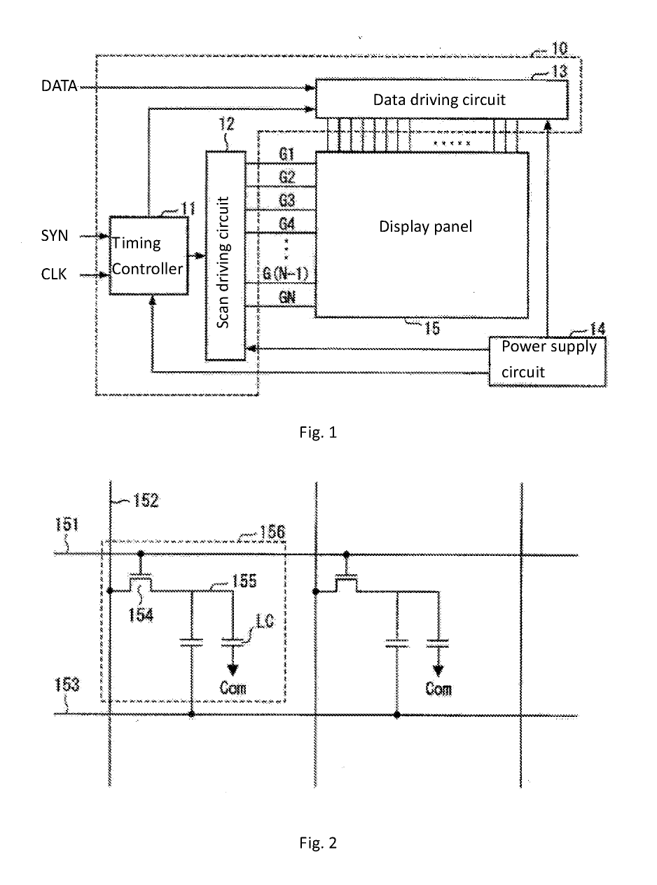

Please refer to FIG. 1. The display device of the present invention comprises a display panel 15 and a driving device 10 that drives the display panel. The display panel 15 comprises a plurality of crossing scan lines and data lines. The driving device comprises:

a scan driving circuit 12, electrically connecting to scan lines to provide scan signals to scan lines;

a data driving circuit 13, electrically connecting to data lines to provide data signals to data lines; and

a timing controller 11 to control signal timing of scan driving circuit and data driving circuit.

The driving device further comprises a power supply circuit 14 to provide power to the timing controller 11, scan driving circuit 12 and data driving circuit 13.

FIG. 2 is a diagram showing part of the display panel 15. The display panel is a LCD panel, although it can be an electroluminescence (EL) panel or plasma display panel.

The display panel 15 comprises a TFT substrate (not shown in the figure), a scan line 151 on the TFT substrate, a data line, a storage capacitor line 153, a TFT 154, a pixel electrode 155, and a common electrode Com. The display panel 15 further comprises a color filter, a polarizer, and an alignment film.

The gate of the TFT 154 connects the scan line 151, the source connects the data line 152, and the drain connects the storage capacitor line 153 through a storage capacitor (not shown in the figure). The source and drain can be switched.

A semiconductor layer of the TFT 154 of the present invention is generally made of amorphous silicon (a-Si, non-crystalline silicon). It can also be made of crystalline silicon or other materials.

The scan line 151 conveys scan signals provided by the scan driving circuit 12 to the TFT 154 connected to the scan line 151. In addition, the data line 152 conveys data signals provided by the data driving circuit 13 to the pixel electrode 155 through the TFT 154 connected to the data line 152.

### Comparative Example

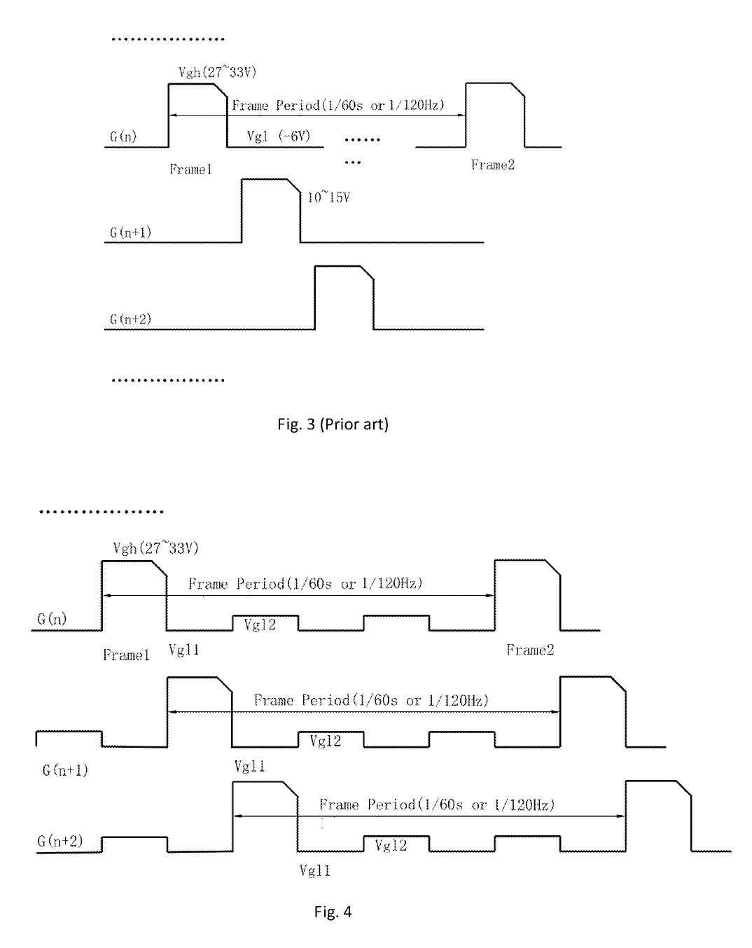

FIG. 3 is a waveform of scan signals applied on the scan lines of the existing technology. A scan signal comprises a plurality of frame signals generated based on a frame period. Each frame signal comprises:

a first voltage Vgh that maintains each scan line in an on state during a first period of time. The first voltage Vgh is a first high-level voltage of DC;

a second voltage that maintains each scan line in an off state during a second period of time. The second voltage Vgl is a low-level voltage of DC.

As each scan line is turned on one after another, scan signals are sent to corresponding pixel electrodes. Because there is a storage capacitor, when scan signals drop from Vgh to Vgl to shut down the TFT, the voltage of liquid crystal capacitor can still remain the same, and thus the display remains stable. This is the basic principle of driving LCD devices.

In the present comparative example, the frame period of the scan driving signal is 1/60 s, the first voltage Vgh is 27V to 33V, and the second voltage Vgl is −6V. The first voltage Vgh further comprises a chamfering voltage that decreases linearly or nonlinearly at the end of the first high-level voltage Vgh. The chamfering voltage decreases by 10V to 15V.

However, when a positive voltage is applied on liquid crystal molecules, because of the effects of the coupled voltage and parasitic voltage, the rechargeable power of pixels will undergo a weak lowering process and partial loss of voltage within the pixels when the scan signals disappear, that is, when the scan signals are in their falling edge. When liquid crystal molecules are applied with reverse current to recharge, there is a slight loss of voltage when the recharge is completed. Given these reasons, asymmetry of voltage exists in pixels on opposite direction after discharging and recharging is completed. A DC is generated inevitably in the liquid crystal cell when the LCD discharges or recharges. When the retention DC is large enough, it prevents liquid crystal molecules from being driven by the signal voltage, and thus image sticking is generated.

In other embodiments, Vgl is raised to improve image sticking. But raising Vgl may easily result in the rising of TFT dark current, influencing TFT's functions and display effect of the LCD.

### Embodiment 1

Please refer to FIG. 4. A scan driving circuit outputs a scan signal to each scan line in the display panel. The scan signal comprises a plurality of frame signals generated based on a frame period. Each frame signal comprises:

a first voltage Vgh that maintains each scan line in an on state during a first period of time, with the first voltage being a first high-level voltage of DC;

a second voltage Vgl that maintains each scan line in an off state during a second period of time, with the second voltage being an alternating voltage outputting a second low-level voltage Vgl1 and a second high-level voltage Vgl2 alternately. The first high level voltage Vgh is larger than the second high level voltage Vgl2.

Moreover, the first voltage comprises a chamfering voltage that decreases linearly or nonlinearly at the end of the first high level voltage Vgh.

The chamfering voltage is for fixing feedthroughs. The delay of scan signals will result in a gap in coupled voltage between near end capacitor and far end capacitor, so that the evenness of the LCD panel deteriorates. Therefore, reducing the high-frequency part of the scan signals based on the low-pass filter principle can narrow the gap in coupled voltage between near end capacitor and far end capacitor. It also lowers the gap in voltage between the near end and far end.

In the present embodiment, the frame period of the scan signals is 1/60 s. The voltage range of the first high-level voltage Vgh is 27V to 33V. The chamfering voltage decreases linearly by a margin from 10V to 15V. The second low-level voltage Vgl1 is −4V. The second high-level voltage Vgl2 is 4V. The midpoint potential of the second low-level voltage Vgl1 and the second high-level voltage Vgl2 is zero.

In the present embodiment, the Vgl changes from being a DC voltage at −6V to an alternating current (AC) voltage. The alternating period (the duration by which the second low-level voltage Vgl1 and second high-level voltage Vgl2 maintain) is consistent with the duration by which the first voltage (the first high-level voltage and the chamfering voltage) maintains. Therefore, between two high-level voltage Vgh, low-level voltage signals periodically fluctuate from −4V to +4V in accordance with different LCDs.

The changes of second low-level voltage Vgl1 and second high-level voltage Vgl2 take place between two successive turn-ons of the TFT. Therefore, the frequency of their changes should be larger than the driving frequency of the display penal. If the driving frequency of the display panel is 60 HZ, the frequency of change of the second voltage (second low-level voltage Vgl1 and second high-level voltage Vgl2) should be at least 120 HZ. The change in frequency can improve image sticking, which is also influenced by amplitude. However, the influence of the frequency and amplitude is not a simple function. The optimum solution can only be found through extensive experiments. In addition, the amplitude of the second voltage cannot be too high, or the leakage current may increase.

Please refer to FIG. 4. When the first voltage of a scan signal completes scan-driving on a nth scan line, the first voltage of a scan signal starts scan-driving on a (n+1)th scan line, and so on and so forth.

The present embodiment changes the second voltage from DC voltage to AC voltage, so that between two turn-ons of scan lines, the remaining voltage of scan lines is higher than the original Vgl. By changing the second voltage Vgl into a high-frequency AC voltage to drive scanning, it helps improve image sticking of display devices.

### Embodiment 2

The first voltage of the present embodiment can comprise only a first high-level voltage Vgh without a chamfering voltage. All the other details are the same as Embodiment 1, so no further explanation is provided here. The present embodiment can also improve image sticking of display devices.

### Embodiment 3

In the present embodiment, the midpoint potential between the second low-level voltage Vgl1 and second high-level voltage Vgl2 is not zero. That is, the absolute value of the second low-level voltage Vgl1 and second high-level voltage Vgl2 is different. For example, the second low-level voltage Vgl1 and second high-level voltage Vgl2 are, respectively, −2V and 6V, 0V and 8V, −6V and 2V, −8V and 0V, and so on and so forth, as long as the second low-level voltage Vgl1 and second high-level voltage Vgl2 can alternate and form an AC voltage. All the other details are the same as Embodiment 1. The present embodiment can also improve image sticking of display devices.

Furthermore, the change of the voltage of the low-level signal ranges from −3V to +3V.

The abovementioned technical solutions describe how the present invention effectively improves the changes in leakage current of TFT of display devices and image sticking of display devices through changing the second voltage that is in charge of maintaining each scan line in an off state into the second low-level voltage and second high-level voltage that output alternately. The method of driving is simple and easy to realize.

The terms “a” or “an”, as used herein, are defined as one or more than one. The term “another”, as used herein, is defined as at least a second or more. The terms “including” and/or “having” as used herein, are defined as comprising. It should be noted that if it is described in the specification that one component is “connected,” “coupled” or “joined” to another component, a third component may be “connected,” “coupled,” and “joined” between the first and second components, although the first component may be directly connected, coupled or joined to the second component.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A method of driving a display panel, comprising:
outputting a scan signal to each scan line of a display panel, with the scan signal comprising a plurality of frame signals generated based on a frame period, with each frame signal comprising:
a first voltage that maintains each scan line in an on state during a first period of time, with the first voltage being a first high-level voltage of direct current (DC);
a second voltage that maintains each scan line in an off state during a second period of time, with the second voltage being an alternating current (AC) voltage outputting a second low-level voltage and a second high-level voltage alternately;
wherein the first high-level voltage is larger than the second high-level voltage.

2. The method of driving of claim 1, wherein the first voltage further comprises a chamfering voltage that decreases linearly or nonlinearly at the end of the first high-level voltage.

3. The method of driving of claim 2, wherein the range of the first voltage is 27V to 33V.

4. The method of driving of claim 1, wherein the second low-level voltage is larger than or equal to −4V, and the second high-level voltage is smaller than or equal to 4V.

5. The method of driving of claim 4, wherein the midpoint potential between the second low-level voltage and second high-level voltage is zero.

6. The method of driving of claim 1, wherein the frame period of the scan signal is 1/60 s.

7. The method of driving of claim 6, wherein the period of the second low-level voltage or second high-level voltage of the second voltage is smaller than or equal to that of the first high-level voltage of the first voltage.

8. The method of driving of claim 1, wherein the duration of the second low-level voltage and second high-level voltage is the same as that of the first high-level voltage.

9. The method of driving of claim 1 further comprising:
starting scan-driving by the first voltage of the scan signal on a (n+1)th scan line when scan-driving is completed by the first voltage of the scan signal on a nth scan line.

10. A driving device, comprising:
a scan driving circuit, electrically connecting to scan lines, to provide scan signals to scan lines;
a data driving circuit, electrically connecting to data lines, to provide data signals to data lines;
a timing controller to control signal timing of the scan driving circuit and data driving circuit;
wherein the scan driving circuit outputs a scan signal to each scan line of the display panel, with the scan signal comprising a plurality of fame signals generated based on a frame period, with each frame signal comprising:
a first voltage that maintains each scan line in an on state during a first period of time, with the first voltage being a first high-level voltage of DC;
a second voltage that maintains each scan line in an off state during a second period of time, with the second voltage being an AC voltage outputting a second low-level voltage and a second high-level voltage alternately;
wherein the first high-level voltage is larger than the second high-level voltage.

11. A display device, comprising a display panel and a driving device for driving the display panel, the display comprising a plurality of crossing scan lines and data lines, the driving device comprising:
a scan driving circuit, electrically connecting to scan lines, to provide scan signals to scan lines;
a data driving circuit, electrically connecting to data lines, to provide data signals to data lines;
a timing controller to control signal timing of the scan driving circuit and data driving circuit;
wherein the scan driving circuit outputs a scan signal to each scan line of the display panel, with the scan signal comprising a plurality of fame signals generated based on a frame period, with each frame signal comprising:
a first voltage that maintains each scan line in an on state during a first period of time, with the first voltage being a first high-level voltage of DC;
a second voltage that maintains each scan line in an off state during a second period of time, with the second voltage being an AC voltage outputting a second low-level voltage and a second high-level voltage alternately;
wherein the first high-level voltage is larger than the second high-level voltage.
